(19) United States
(12) Patent Application Publication
(10) Pub. No.: US 2026/0225923 A1
(43) Pub. Date: Aug. 6, 2026

(54) RECOVERY OF KINETIC HYDRATE INHIBITORS FROM PRODUCED WATER BY MEMBRANE FILTRATION

(71) Applicant: Saudi Arabian Oil Company, Dhahran (SA)

(72) Inventors: Qiwei Wang, Dhahran (SA); Husain H. Bar, Dammam (SA)

(21) Appl. No.: 19/045,885

(22) Filed: Feb. 5, 2025

(51) Int. Cl. C02F 1/44; C02F 1/66; C02F 1/68; C02F 101/10

(52) U.S. Cl. CPC C02F 1/444; C02F 1/66; C02F 1/68; C02F 2101/101; C02F 2305/00

(57) ABSTRACT

A produced water stream that includes a kinetic hydrate inhibitor (KHI) flows towards a water oil separator (WOSEP). The WOSEP removes the large oil droplets and total suspended solids and discharges the produced water stream with or without an additional pretreatment step to a membrane separation unit. The membrane separation unit filters the produced water stream to form a permeate stream and a retentate stream. The retentate stream includes the concentrated KHI which can be recovered and regenerated for reuse as a treatment chemical in the produced water stream. In some cases, the retentate stream is filtered a second time using another membrane separation unit to increase the KHI recovery by concentrating it in a second retentate stream formed from the second filtration. The KHI can be reformulated using alcohols and/or water to regenerate the KHI molecules for reuse, which are chemically stable.

### TECHNICAL FIELD

This disclosure relates to methods of treating produced water.

### BACKGROUND

During the production of oil and gas, a three phase separator is used to separate gas and water from crude oil. The separated water is known as produced water, which can be reused in various facilities after treatment. The produced water includes several contaminants depending on the nature of the formation, the formation fluids present during production, and the chemicals injected during the production process. Some of the chemicals injected during the treatment of produced water include inhibitors, pH control agents, and hardness removing agents.

### SUMMARY

Implementations described here provide a method for the recovery of kinetic hydrate inhibitor from produced water by membrane filtration.

### BRIEF DESCRIPTION OF DRAWINGS

FIG. 1A is a schematic representation of a process to recover KHI from produced water in a single pass treatment using an ultrafiltration (UF) membrane.

FIG. 1B is a schematic representation of a process to recover KHI from produced water in a two pass treatment using an UF membrane.

FIG. 2 is a schematic diagram of a process to regenerate KHI from the UF filtered retentate.

FIG. 3 is a process flow diagram of the method to regenerate a treatment chemical from a produced water stream.

### DETAILED DESCRIPTION

The formation of gas hydrates is a consideration in flow assurance during oil and gas production. Gas hydrates are ice like solid compounds that form under high pressure and low temperature conditions in the presence of both water and light hydrocarbon molecules. The management of gas hydrates plays a role in oil and gas production systems. Hydrate plugs can cause rapid blockages and are considered hazardous. Chemical inhibitors are used to mitigate hydrate formation in production systems where the temperature falls below the hydrate equilibrium temperature (HET). One of the chemical inhibitors used to manage risks associated with hydrate formation is a kinetic hydrate inhibitor (KHI). KHIs are commonly applied at concentrations of 1-2% (up to 5%) of produced water. However, KHIs are lost with produced water after a single use, leading to the consumption of large quantities of chemicals, unless managed effectively. Further, reinjecting the produced water that includes the KHI into a well can cause a long term reservoir damage.

Implementations described here provide an integrated water treatment system and a method to recover KHIs from produced water. KHIs, after use, are found in the produced water stream. The produced water stream undergoes a separation process in a water oil separator (WOSEP). The WOSEP separates large oil particles and discharges an output produced water stream, free of large oil particles. In some implementations, the produced water stream that exits the WOSEP undergoes a pretreatment process to further remove small oil droplets and total suspended solids (TSS) to produce a pretreated produced water stream. The pretreated produced water stream undergoes a membrane separation process. In some implementations, a UF, nanofiltration (NF), or reverse osmosis membrane is used for the membrane separation process. In some implementations, a UF membrane is used as it is less prone to membrane fouling and less energy intensive compared to the NF or RO membrane.

The UF membrane filters the pretreated produced water stream to produce a permeate stream and a retentate stream. The permeate stream is substantially water molecules. The retentate stream can include total dissolved solids (TDS), dissolved ions, and small chemical molecules such as KHIs. The KHI in the retentate stream is further analyzed to determine the chemical and physical properties of the molecule. The UF membrane filtration can occur in a single pass step or in a two pass step. In a single pass step, the pretreated produced water forms a first permeate stream and a first retentate stream. In a two pass step, the first retentate obtained from the single pass step is filtered a second time to form a second permeate stream and a second retentate stream. The KHI molecules are further concentrated in the second retentate stream.

In some implementations, the KHI molecules obtained in the first retentate stream or the second retentate stream are formulated with alcohol or water to regenerate the KHI for reuse during oil and gas production. In some implementations, a substantial amount of sulfate ions is present in the first retentate stream or the second retentate stream. In this case, the first retentate or second retentate stream is treated with barium chloride salt to form barium sulfate precipitate. The precipitate is siphoned out, and the KHI is recovered and formulated with an alcohol or water to regenerate the KHI.

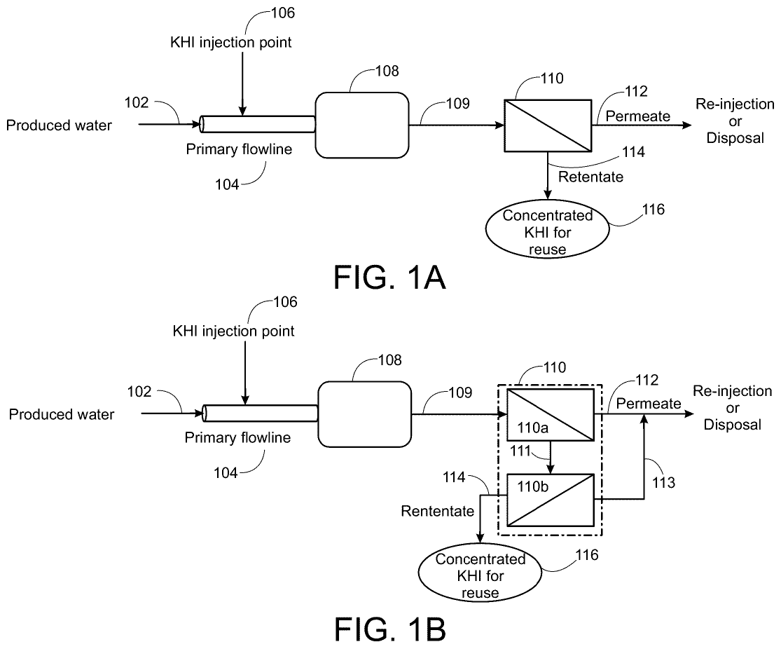

FIG. 1A is a schematic representation of a process to recover KHI in a single pass treatment using an ultrafiltration (UF) membrane. Produced water is formed during a three phase separation in a gas oil separation plant (GOSP). The three phase separation involves the removal of dissolved gas and water (referred to as produced water) from the crude oil. The crude oil is processed in a dehydrator and desalter for exporting to pipelines. The separated gas is processed in a gas plant. The separated produced water 102 flows through a primary flowline 104 towards a WOSEP 108 for further processing.

Produced water 102 in a GOSP can include several contaminants such as large and small oil droplets, TSS, TDS, dissolved hydrogen sulfide (H₂S), and hardness causing ions. The contaminants found in the produced water 102 depend on the type of geology and formation brine present in the reservoir. In addition to these contaminants, treatment chemicals such as KHIs are injected along the flowline 104 at an injection point 106. In some implementations, the treatment chemicals can include scale inhibitors, corrosion inhibitors, biocides, coagulants, flocculants, and pH control agents.

In the WOSEP 108, large oil droplets and TSS are removed by gravity separation. The presence of oil droplets can contaminate the membrane filter in the downstream process. The produced water stream 109 after separation in the WOSEP 108 flows towards a membrane separation unit 110. In some implementations, a pretreatment unit is used to further remove the contaminants prior to flowing the produced water stream 109 to the membrane separation unit 110. The pretreatment unit can include a hydroclone or nutshell filter, an air stripper unit, an adsorption media, a pellet softener, and a ceramic filtration unit. The pretreatment unit removes emulsified oil droplets, dissolved H₂S gas, volatile organic compounds (VOCs), hardness, and any remaining dissolved oil. However, small chemical molecules such as KHI still remain in the produced water stream 109 after pretreatment, which are removed by the membrane separation unit 110.

The membrane separation unit 110 can include an RO, NF, or a UF membrane. Among these, UF membrane is less prone to fouling. Additionally, the filtration process by a UF membrane is less energy intensive as it operates under reduced pressure. UF works based on the principle of size exclusion. The UF membrane is selected with a pore size based on the size of the KHI molecule to be recovered. The right UF membrane pore size will enhance KHI recovery.

The UF membrane has pore sizes ranging from 0.001 to 0.2 microns (μm). In some implementations, the pore size of the UF membrane ranges between 0.02-0.05 μm. The UF membrane is made up of hollow fibers of polyvinylidene fluoride (PVDF) polymer. The PVDF hollow fibers have high strength and chemical resistance. Additionally, the PVDF fibers can be made hydrophilic to have good wetting properties. The PVDF fibers are easy to clean and have a long-term performance. The hollow fibers of the UF membrane can also include other polymeric materials such as polysulfone, polyvinyl chloride, or polyethersulfone. Besides the hollow fiber configuration, the UF membrane can also include tubular, frame, plate, and spiral wound configurations.

Under pressure, the produced water stream 109 flows through the hollow fibers of the semipermeable UF membrane in a single pass. The produced water stream 109 is cooled to a temperature 70° F. or lesser (21° C. or lesser) before flowing through the UF membrane. The UF membrane filtration produces a first permeate stream 112 and a first retentate stream 114. The first permeate stream 112 includes small molecules such as water and low molecular weight solutes such as monovalent ions. The monovalent ions can include sodium, potassium, chloride, or bicarbonate. In some implementations, divalent cations such as calcium, magnesium, and strontium, pass through the UF membrane and are found in the first permeate stream 112. Large molecules such as KHI molecules, residual suspended solids, and sulfate anions concentrate in the first retentate stream 114. Based on the efficiency of the UF membrane, 98-100% of the KHI molecules can be obtained in the first retentate stream 114. In some implementations, the first permeate stream 112 can include a low concentration (0.5-2% of total permeate volume) of KHI molecules that were not captured in the first retentate stream 114. In this case the first permeate stream 112 that includes the KHI is reinjected into the produced water stream 102. In some implementations, the first permeate stream 112 that includes the low concentration of KHIs is disposed. The first retentate stream 114 includes all or most of the KHIs (98-100%). All or at least a portion of the active ingredients of the KHIs in the first retentate stream 114 are recovered for reuse.

KHIs are chemical inhibitors that work by delaying or impeding the nucleation or the growth of hydrate formation. KHI molecules attach to the hydrate crystal through hydrogen bonding, thereby blocking further growth of that crystal. KHIs can prevent hydrate formation for a finite time duration. This time duration is referred to as the hold time or induction time of the KHI. KHIs are injected at 1-2 vol. % of produced water rate, while much higher concentrations, i.e., <5% can be used in some operations.

The KHIs injected into produced water include water-soluble polymers that have pyrrolidone and caprolactam based structures. The resulting KHI molecules include poly-vinylpyrrolidone (PVP) and poly-vinylcaprolactam (PVCap). KHI molecules can also include co-polymers of N-vinylpyrrolidone (VP) and N-vinylcaprolactam (VC), polyalkylacrylamides, N-methyl-N-vinylacetamide: PVCap copolymer (VIMA:PVCap), polyacryloylpyrrolidine (polyAP), mixtures of tetrabutylammonium bromide (TBAB) and PVCap, mixtures of TBAB and VCL, or polyesteramides. The water soluble polymers used as KHIs do not undergo chemical degradation during the produced water treatment. Therefore, the KHI molecules maintain their original chemical structure in the first retentate 114.

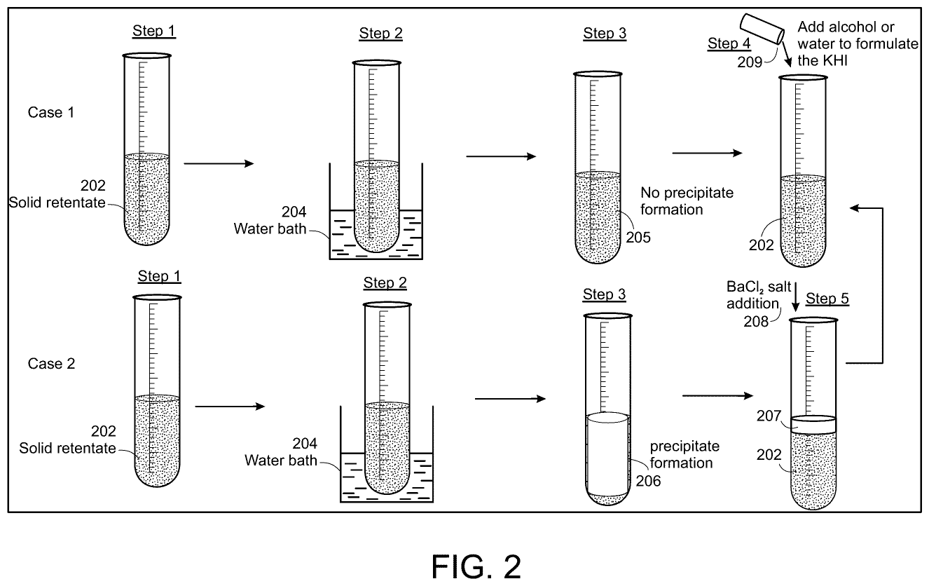

The first retentate stream 114 that includes the KHI molecules undergoes a quality test. Various physical and chemical properties of the first retentate 114 are assessed, such as the presence of solids and the chemical composition of the active ingredients of the KHI. Further, the determination of physical and chemical properties include measuring the pH and freeze temperature. A pH meter is used to measure the pH, while freeze temperature is determined by placing a sample into a freezer at a pre-set temperature. Any solid residue presence in the first retentate 114 is removed by medium filtration to concentrate the active ingredients of the KHI. The results of the chemical and physical test determine the KHI regeneration process. The KHIs are regenerated by using alcohols or water as the reformulation agents. In some implementations, glycol, 2-butoxyethanol, and/or water are used as the reformulating agents. A detailed process for the regeneration of KHIs is provided with the description of FIG. 2 below. The regenerated (recovered) KHIs 116 can be injected into the produced water 102.

At the end of the one pass UF membrane filtration process, the UF membrane is backflushed with water to prevent membrane fouling. In some implementations, the backflush water is mixed with the produced water flowing towards the WOSEP 108 for further processing. In some cases, the backflush water is discarded.

FIG. 1B is a schematic representation of a process to recover KHI in a two pass treatment using an UF membrane. Similar to the description of FIG. 1A, a produced water stream 102 from a GOSP flows through a primary flowline 104 towards a WOSEP 108. At a certain injection point 106 of the primary flowline 104, treatment chemicals are injected into the produced water 102. The treatment chemicals can include a KHI. In some implementations, the treatment chemicals include a corrosion inhibitor, a scale inhibitor, pH control agents, H₂S scavenging agents, and hardness reducing agents. A KHI is a chemical inhibitor that is used to reduce or prevent gas hydrate formation, especially at high temperature and low pressure conditions.

Produced water 102 includes several contaminants such as large oil droplets, emulsified oil droplets, VOCs, dissolved gases, TSS, and TDS. In the WOSEP 108, the produced water 102 that includes the KHI undergoes a separation process that results in the removal of large oil droplets and TSS. The produced water stream 109 after separation in a WOSEP 108 is directed towards a membrane separation unit 110. In some implementations, prior to flowing towards the membrane separation unit 110, the produced water stream 109 is directed to a pretreatment unit. A pretreatment unit treats the produced water stream 109 to remove the emulsified oil droplets, VOCs, dissolved H₂S, hardness, and the remaining dissolved oils.

After pretreatment, the membrane separation unit 110 filters the produced water stream 109 that includes the KHI. In some implementations, the membrane separation unit 110 includes a first UF membrane 110a and a second UF membrane 110b. The pore size of both the UF membrane 110a and the second UF membrane 110b are selected based on the size of the KHI molecule.

In a single pass filtration method the produced water stream 109 flows through the first UF membrane 110a. This results in a first retentate stream 111 which includes the KHI molecules and a first permeate stream 112. In a two pass filtration method, the first retentate stream 111 is filtered a second time by the second UF membrane 110b to produce a concentrated retentate 114 and a second permeate stream 113. In some implementations, the second permeate stream 113 is mixed with the first permeate stream 112. The concentrated retentate 114 includes a higher amount of recovered KHIs than the first retentate stream 111. The concentrated retentate 114 is reformulated with alcohols and/or water to regenerate the KHIs. The alcohols include glycol or 2-butoxyethanol. The regenerated KHIs 116 are reinjected into the produced water stream 102. The chemical composition of the regenerated KHIs 116 can be adjusted based on the requirements of the produced water. The first permeate stream 112 and the second permeate stream 113 are re-injected into a well or disposed.

FIG. 2 is a schematic diagram of a process to regenerate KHI from the UF filtered retentate. In some implementations, the first retentate stream 114 (FIG. 1A) or the concentrated retentate 114 (FIG. 1B) is analyzed for the presence of sulfate ions. Monovalent ions and divalent cations pass through the UF membrane into the permeate stream. However, divalent anions such as sulfate ions concentrate in either the first retentate stream 114 (FIG. 1A) or the concentrated retentate (FIG. 1B). To analyze for sulfate ions, a compatibility test is conducted. In the compatibility test, several samples of the first retentate stream 114 or the concentrated retentate 114 (hereafter referred to as retentate samples 202) are collected. In step 1, the retentate samples 202 are mixed with the produced water at different ratios. For example, the mixing ratios include 10:90, 20:80, 30:70,40:60, 50:50, 90:10, and so on. The sulfate ions react with the dissolved calcium, strontium, or barium in produced water to form solid precipitates in the form of calcium sulfate, strontium sulfate, and barium sulfate.

Case 1

In step 2, the mixed samples are placed in a water bath 204 with the temperature set at the temperature of the injection point 106 (FIG. 1A and FIG. 1B). In step 3, the mixed samples are observed for the formation of solid precipitates for a time period of 2-24 hours. In some implementations, the time period can include a range of 2-6 hours. If no solid precipitates 205 are observed as in Case 1, the retentate samples 202 are reformulated with reformulating agents 209 such as alcohols and/or water. The alcohols can include 2-butoxyethanol or glycol to regenerate KHIs. Alcohols are chosen for reformulation to reduce the freeze temperature. Water is used to adjust the concentration. Further, the chemical composition of the regenerated KHIs can be adjusted via reformulation to meet the performance efficacy and physical property requirements of the produced water to be treated. The adjustment to the chemical composition of the regenerated KHIs include but not limited to changes in the pH, density, viscosity, and freezing point.

Case 2

In step 1, retentate samples 202 are mixed with produced water at different ratios. In step 2, the mixed samples are placed in a water bath 204 with the temperature set at the temperature of the injection point 106 (FIG. 1A and FIG. 1B). In step 3, the mixed samples of the retentate samples 202 and the produced water in the water bath 204 show the formation of solid precipitates 206 after about 2-24 hours. This occurs due to the presence of sulfate ions. In this case, the retentate samples 202 are directed to a treatment process as shown in step 5. In step 5, the retentate samples 202 are treated with barium chloride salt 208 to form barium sulfate precipitates 207. The reaction time for the formation of barium sulfate precipitate 207 ranges between 2-24 hours. The barium sulfate precipitates 207 are removed using a filter. The amount of barium chloride salt 208 added is equal to the molar concentration of sulfate ions in the retentate sample 202. After removing the barium sulfate precipitates 207, the treated retentate sample is directed to step 4, where the treated retentate sample is reformulated with reformulating agents 209 such as glycol, 2-butoxyethanol, and /r water to regenerate the KHIs. The regenerated KHIs can be reused for treating the produced water.

In some implementations, scaling ions such as sulfate is highly concentrated in the retentate stream. In such cases, scale inhibitors based on organophosphate and polymeric carboxylate are added to prevent the inorganic salt precipitation (sulfate precipitates), when the regenerated KHI is added to produced water.

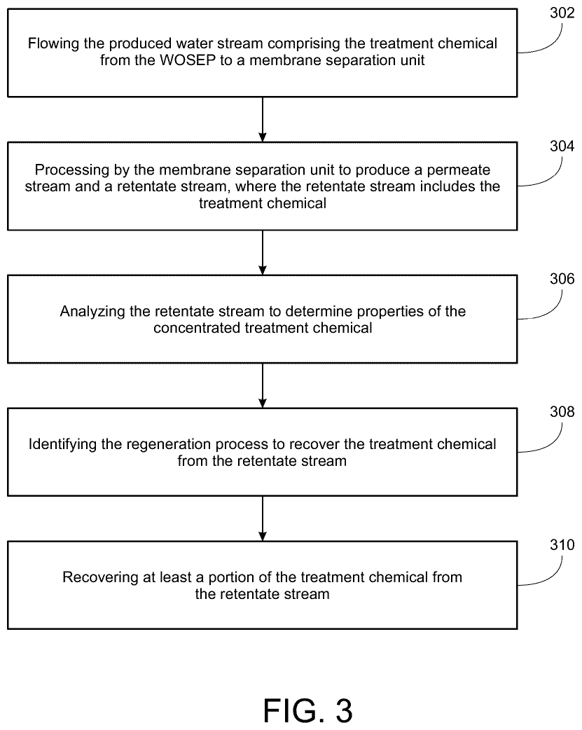

FIG. 3 is a process flow diagram of the method to regenerate a treatment chemical from a produced water stream. At block 302, the produced water stream flows towards a WOSEP. The produced water stream includes several contaminants such as large oil droplets, TSS, TDS, VOCs, dissolved gases, and hardness causing ions. In addition, as the produced water stream flows through a flowline, treatment chemicals are injected into the produced water stream. The treatment chemicals can include a KHI, a scale inhibitor, or a corrosion inhibitor.

In some implementations, a KHI is injected into the produced water stream to prevent or reduce the formation of gas hydrates. Gas hydrates form at high temperature and low pressure. They can cause rapid blockages in the pipeline and other facilities which lead to a shutdown. KHIs which are used to prevent gas hydrate formation include water soluble polymer molecules. The KHI molecules include water soluble amide polymers or homopolymers. The KHIs include poly-vinylpyrrolidone (PVP) and poly-vinylcaprolactam (PVCap). KHI molecules can also include co-polymers of N-vinylpyrrolidone (VP) and N-vinylcaprolactam (VC), polyalkylacrylamides, N-methyl-N-vinylacetamide: PVCap copolymer (VIMA:PVCap), polyacryloylpyrrolidine (polyAP), mixtures of tetrabutylammonium bromide (TBAB) and PVCap, mixtures of TBAB and VCL, or polyesteramides.

In a WOSEP, the large oil droplets and TSS are removed from the produced water stream. The produced water stream from the WOSEP is then directed to a membrane separation unit. In some implementations, the produced water stream is pretreated by various physical and chemical methods before flowing to the membrane separation unit.

At block 304, the membrane separation unit processes the produced water stream received from the WOSEP or the pretreatment unit. The membrane separation unit includes a UF membrane. In some implementations, a RO or a NF membrane are used. However, a UF membrane is preferable due to lesser membrane fouling. Additionally, the UF membrane is less energy intensive. In some implementations, the UF membrane includes hollow fibers of PVDF. The pore size of the UF membrane is selected based on the size of the KHI molecule. The produced water stream flows under pressure through the UF membrane in a single pass. The UF membrane produces a permeate stream and a retentate stream. The KHI is concentrated in the retentate stream. In some implementations, monovalent ions and divalent ions are obtained in the retentate stream along with the KHI molecules.

In some implementations, the produced water stream is filtered in a two pass mode. In a two pass mode, two UF membranes are used for the filtration process. The first UF membrane produces a first permeate stream and a first retentate stream. The KHI molecules are present in the first retentate stream. The first retentate stream is filtered a second time using a second UF membrane. The second UF membrane produces a second permeate stream and a concentrated retentate stream. The KHI molecules are further concentrated in the concentrated retentate stream, which can enhance KHI recovery.

At block 306, the retentate stream is analyzed to determine the physical and chemical properties of the treatment chemical, such as the KHI. Several experimental assessments are made to check for the presence of solid residue in the retentate. Further, the chemical composition of the retentate is analyzed. If solid residue is present, a medium filtration is used to remove the solid residue. Additionally, a compatibility test is conducted to check for the presence of sulfate ions in the retentate.

The compatibility test involves mixing a sample of the retentate with produced water at different ratios, resulting in several mixed samples. The mixed samples are placed in a water bath. The water bath is set to a temperature as the KHI injection point in the flow line. The mixed samples are observed for the formation of precipitates after a time period of 2-24 hours. If no precipitates are formed, the retentate is reformulated to regenerate the KHI. If precipitate formation is observed, a treatment method is performed to remove the precipitates. Solid precipitates are formed due to the presence of sulfate ions. In this case, barium chloride salt is added to the mixed samples. This results in barium sulfate precipitates which are siphoned out using a filter. Then the retentate sample free of sulfate ions is reformulated to regenerate the KHIs.

At block 308, a regeneration method is identified to regenerate the KHIs. To regenerate the KHI from the retentate, alcohols and/or water are used. The alcohols include glycol, 2-butoxyethanol, or other branched chain alcohols. The alcohols and water are mixed with the retentate to regenerate the KHI. In some implementations, acid or caustic reagents are added to adjust the pH. In some cases, scale inhibitors are added to the retentate. The KHI molecules do not undergo chemical degradation during flow of the produced water stream though the various flowlines, valves, and fittings. Therefore, the regenerated KHIs can be reused in the produced water for treatment.

At block 310, at least a portion of the active ingredients of the KHI is recovered for reuse along with the produced water stream. In some implementations, the KHI molecules are recovered from the first retentate stream obtained from the use of a single UF membrane. In some implementations, the KHI molecules are recovered from the concentrated retentate which is obtained while two UF membranes are used. The recovered KHI molecules are reinjected into the produced water stream.

The UF membrane concentrates the KHI molecules from a produced water stream. The process can be done in a single pass filtration or by a two pass filtration. In some implementations, multiple filtrations using UF membranes of different pore sizes are used to recover a mixture of KHI molecules with differing chemical structures. In some cases, a combination of UF membrane, NF membrane, and RO membrane can be used as well.

Implementations disclosed here can effectively recover KHIs and thereby reduce chemical consumption. Recovery and reuse of KHI also prevents long term reservoir degradation, which occurs when the KHI chemicals are disposed into wells.

### EXAMPLES

Certain aspects of the subject matter described here can be implemented as a method to regenerate a treatment chemical from a produced water stream. The produced water stream that includes the treatment chemical flows from a WOSEP to a membrane separation unit. The membrane separation unit processes the produced water stream to form a permeate stream and a retentate stream, where the treatment chemical is concentrated in the retentate stream. The retentate stream is analyzed to determine properties of the concentrated treatment chemical. Based on the results of analyzing the retentate stream, regeneration processes are identified to recover the treatment chemical from the retentate stream. At least a portion of the treatment chemical is recovered from the retentate stream by performing one or more regeneration processes.

An aspect combinable with any other aspect includes the following features. The membrane separation unit is a first membrane separation unit, where the permeate stream is a first permeate stream and the retentate stream is a first retentate stream. The first membrane separation unit processes the produced water stream in a first pass. The first retentate stream from the first membrane separation unit is sent to a second membrane separation unit. The second membrane separation unit processes the first retentate stream to produce a second retentate stream and a second permeate stream, where the treatment chemical is concentrated in the second retentate stream. The second retentate stream is analyzed to determine the properties of the treatment chemical. The result of the analysis is used to identify the regeneration process to recover the treatment chemical from the second retentate stream. At least a portion of the treatment chemical is recovered from the second retentate stream by performing one or more of the regeneration processes.

An aspect combinable with any other aspect includes the following features. The method further includes flowing the second permeate stream to mix with the first permeate stream.

An aspect combinable with any other aspect includes the following features. The recovered treatment chemical is further used to treat the produced water stream.

An aspect combinable with any other aspect includes the following features. The retentate stream is analyzed to determine properties of the concentrated treatment chemical if it is in solid form. Based on the analysis, the regeneration process is identified to recover the treatment chemical. Filtration is identified as a regeneration process to recover the concentrated treatment chemical from the solid form and at least a portion of the treatment chemical is recovered from the retentate stream by filtering the retentate stream.

An aspect combinable with any other aspect includes the following features. A compatibility test of the retentate stream with the produced water stream is conducted.

An aspect combinable with any other aspect includes the following features. In response to the compatibility test, it is determined that the retentate stream is compatible with the produced water stream and the recovered treatment chemical is formulated with ethylene glycol, 2-butoxyethanol, or water to regenerate the recovered treatment chemical.

An aspect combinable with any other aspect includes the following features. In response to the compatibility test, it is determined that the retentate stream is incompatible with the produced water stream and barium chloride salt is added to the retentate stream to remove sulfate anions by forming barium sulfate precipitate.

An aspect combinable with any other aspect includes the following features. The compatibility test includes mixing the retentate stream with the produced water stream at varying ratios forming several sample mixtures. The sample mixtures are heated to a temperature corresponding to the temperature of a flowline at which the treatment chemical is injected into the produced water stream. The sample mixtures are analyzed for the formation of a precipitate after a time period of about 2 hours.

An aspect combinable with any other aspect includes the following features. The membrane separation unit includes an ultrafiltration membrane.

An aspect combinable with any other aspect includes the following features. The ultrafiltration membrane includes hollow fibers made from polyvinylidene fluoride (PVDF) polymer, where the ultrafiltration membrane processes the produced water stream to form the retentate stream by capturing the treatment chemical in the hollow fibers of the PVDF polymer.

An aspect combinable with any other aspect includes the following features. The active ingredients of the treatment chemical include water soluble amide polymers or homopolymers.

An aspect combinable with any other aspect includes the following features. The active ingredients of the treatment chemical include N-vinylpyrrolidone (VP), N-vinylcaprolactam (VCL), N-isopropylmethacrylamide (NIPMAm), or copolymers of VP, VCL, NIPMAm, polyalkylacrylamides, N-methyl-N-vinylacetamide, polyacryloylpyrrolidine, mixtures of tetrabutylammonium bromide and VCL, or polyesteramides.

An aspect combinable with any other aspect includes the following features. The treatment chemical includes kinetic hydrate inhibitors.

Certain aspects of the subject matter described here can be implemented as a method for KHI recovery. A membrane separation unit receives a produced water stream that includes the KHI, from a WOSEP. The membrane separation unit filters the produced water stream to form a permeate stream and a retentate stream, where the KHI is concentrated in the retentate stream. The retentate stream is analyzed to determine properties of the KHI. Based on the results of the analysis of the retentate stream, a regeneration process is identified to recover the KHI from the retentate stream. At least a portion of the KHI is recovered from the retentate stream by performing one or more of the regeneration processes.

An aspect combinable with any other aspect includes the following features. The produced water stream is filtered by a first ultrafiltration membrane in a first pass to form a first permeate stream and a first retentate stream. The first retentate stream is sent into a second ultrafiltration membrane to produce a second permeate stream and a second retentate stream, where the KHI is further concentrated in the second retentate stream. The second retentate stream is analyzed to determine properties of the KHI. Based on the results of the analysis, a regeneration process is identified to recover the KHI from the second retentate stream. At least a portion of the KHI is recovered from the second retentate stream by performing one or more regeneration processes.

An aspect combinable with any other aspect includes the following features. The analysis of the retentate stream to determine the properties of the concentrated KHI include determining that the concentrated KHI is in solid form. Based on the results of analyzing the retentate stream, filtration is identified as the regeneration process to recover the concentrated KHI from the solid form. At least a portion of the KHI is recovered from the retentate stream by filtering the retentate stream.

An aspect combinable with any other aspect includes the following features. The method further includes conducting a compatibility test of the retentate stream with the produced water stream, and in response to determining the compatibility of the retentate stream with the produced water stream, the recovered KHI is formulated with ethylene glycol, 2-butoxyethanol, or water to regenerate the KHI.

An aspect combinable with any other aspect includes the following features. The KHI includes N-vinylpyrrolidone (VP), N-vinylcaprolactam (VCL), N-isopropylmethacrylamide (NIPMAm), or copolymers of VP, VCL, NIPMAm, polyalkylacrylamides, N-methyl-N-vinylacetamide, polyacryloylpyrrolidine, mixtures of tetrabutylammonium bromide and VCL, or polyesteramides.

Certain aspects of the subject matter described here can be implemented as a water treatment system. The system includes a flowline configured to flow a produced water stream. An injection point along the flowline is configured to receive an injected KHI. A WOSEP connected to the flowline is configured to receive the produced water stream that includes the KHI. A pretreatment system downstream of the WOSEP is configured to treat the produced water stream to remove oil droplets and suspended solids, resulting in a pretreated produced water stream. The pretreated produced water stream flows into a membrane separation unit which is placed downstream of the pretreatment system. The membrane separation unit produces a permeate stream and a retentate stream, where the KHI is concentrated in the retentate stream. An analyzer is configured to analyze the retentate stream to determine the properties of the concentrated KHI. A regeneration process subsystem is configured to recover the KHI from the retentate stream.

Other implementations are also within the scope of the following claims.

1. A method of regenerating a treatment chemical in a produced water stream, the method comprising:
flowing the produced water stream comprising the treatment chemical from a water oil separator (WOSEP) to a membrane separation unit;
processing, by the membrane separation unit, the produced water stream to form a permeate stream and a retentate stream, wherein the treatment chemical is concentrated in the retentate stream;
analyzing the retentate stream to determine properties of the concentrated treatment chemical;
based on results of analyzing the retentate stream, identifying regeneration processes to recover the treatment chemical from the retentate stream; and
recovering at least a portion of the treatment chemical from the retentate stream by performing one or more of the regeneration processes.

2. The method of claim 1, wherein the membrane separation unit is a first membrane separation unit, the permeate stream is a first permeate stream and the retentate stream is a first retentate stream wherein:
processing, by the first membrane separation unit, the produced water stream comprises processing the produced water stream in a first pass, wherein the method further comprises:
flowing the first retentate stream from the first membrane separation unit to a second membrane separation unit;
processing, by the second membrane separation unit, the first retentate stream to produce a second permeate stream and a second retentate stream, wherein the treatment chemical is further concentrated in the second retentate stream;
analyzing the second retentate stream to determine properties of the concentrated treatment chemical in the second retentate stream;
based on results of analyzing the second retentate stream, identifying regeneration processes to recover the treatment chemical from the second retentate stream; and
recovering at least a portion of the treatment chemical from the second retentate stream by performing one or more of the regeneration processes.

3. The method of claim 2, further comprising flowing the second permeate stream to mix with the first permeate stream.

4. The method of claim 2, further comprising using the recovered treatment chemical to treat the produced water stream.

5. The method of claim 1, wherein analyzing the retentate stream to determine properties of the concentrated treatment chemical in the retentate stream comprises determining that the concentrated treatment chemical is in solid form;
based on results of analyzing the retentate stream, identifying regeneration processes to recover the treatment chemical from the retentate stream comprises identifying filtration as a regeneration process to recover the concentrated treatment chemical from the solid form; and
recovering at least a portion of the treatment chemical from the retentate stream comprises filtering the retentate stream.

6. The method of claim 5, further comprising conducting a compatibility test of the retentate stream with the produced water stream.

7. The method of claim 6, wherein in response to conducting the compatibility test, determining that the retentate stream is compatible with the produced water stream; and
formulating the recovered treatment chemical with ethylene glycol, 2-butoxyethanol, or water to regenerate the recovered treatment chemical.

8. The method of claim 6, wherein in response to conducting the compatibility test, determining that the retentate stream is incompatible with the produced water stream; and
adding barium chloride salt to the retentate stream to remove sulfate anions by forming barium sulfate precipitate.

9. The method of claim 6, wherein conducting a compatibility test comprises:
mixing the retentate stream with the produced water stream at varying ratios forming a plurality of sample mixtures;
heating the plurality of sample mixtures to a temperature corresponding to a temperature of a flowline at which the treatment chemical is injected into the produced water stream; and
analyzing the plurality of sample mixtures for the formation of a precipitate after a time period of about 2 hours.

10. The method of claim 1, wherein the membrane separation unit comprises an ultrafiltration membrane.

11. The method of claim 10, wherein the ultrafiltration membrane comprises hollow fibers made from polyvinylidene fluoride (PVDF) polymer, wherein processing, by the ultrafiltration membrane, the produced water stream to form the retentate stream comprises capturing the treatment chemical in the hollow fibers of the PVDF polymer.

12. The method of claim 1, wherein active ingredients of the treatment chemical comprise water soluble amide polymers or homopolymers.

13. The method of claim 12, wherein the active ingredients of the treatment chemical comprise N-vinylpyrrolidone (VP), N-vinylcaprolactam (VCL), N-isopropylmethacrylamide (NIPMAm), or copolymers of VP, VCL, NIPMAm, polyalkylacrylamides, N-methyl-N-vinylacetamide, polyacryloylpyrrolidine, mixtures of tetrabutylammonium bromide and VCL, or polyesteramides.

14. The method of claim 1, wherein the treatment chemical comprises kinetic hydrate inhibitors.

15. A kinetic hydrate inhibitor (KHI) recovery method comprising:
receiving, by a membrane separation unit, a produced water stream comprising the KHI from a water oil separation (WOSEP);
filtering, by the membrane separation unit, the produced water stream to form a permeate stream and a retentate stream, wherein the KHI is concentrated in the retentate stream;
analyzing the retentate stream to determine properties of the KHI;
based on results of analyzing the retentate stream, identifying regeneration processes to recover KHI from the retentate stream; and
recovering at least a portion of the KHI from the retentate stream by performing one or more of the regeneration processes.

16. The method of claim 15, wherein filtering by the membrane separation unit comprises:
filtering the produced water stream by a first ultrafiltration membrane in a first pass to form a first permeate stream and a first retentate stream;
flowing the first retentate stream to a second ultrafiltration membrane to produce a second permeate stream and a second retentate stream, wherein the KHI is further concentrated in the second retentate stream;
analyzing the second retentate stream to determine properties of the KHI in the second retentate stream;
based on results of analyzing the second retentate stream, identifying regeneration processes to recover the KHI from the second retentate stream; and
recovering at least a portion of the KHI from the second retentate stream by performing one or more of the regeneration processes.

17. The method of claim 15, wherein analyzing the retentate stream to determine properties of the concentrated KHI in the retentate stream comprises:
determining that the concentrated KHI is in solid form;
based on results of analyzing the retentate stream, identifying regeneration processes to recover the KHI from the retentate stream comprises identifying filtration as a regeneration process to recover the concentrated treatment chemical from the solid form; and
recovering at least a portion of the KHI from the retentate stream comprises filtering the retentate stream.

18. The method of claim 17, further comprising conducting a compatibility test of the retentate stream with the produced water stream, and in response to determining the compatibility of the retentate stream with the produced water stream, formulating the recovered KHI with ethylene glycol, 2-butoxyethanol, or water to regenerate the KHI.

19. The method of claim 18, wherein the KHI comprises N-vinylpyrrolidone (VP), N-vinylcaprolactam (VCL), N-isopropylmethacrylamide (NIPMAm), or copolymers of VP, VCL, NIPMAm, polyalkylacrylamides, N-methyl-N-vinylacetamide, polyacryloylpyrrolidine, mixtures of tetrabutylammonium bromide and VCL, or polyesteramides.

20. A water treatment system comprising:
a flowline configured to flow a produced water stream;
an injection point along the flowline, the injection point configured to receive an injected kinetic hydrate inhibitor (KHI);
a water oil separator (WOSEP) connected to the flowline, the WOSEP configured to receive the produced water stream comprising the KHI;
a pretreatment system downstream of the WOSEP, the pretreatment system configured to treat the produced water stream to remove oil droplets and a plurality of suspended solids, resulting in a pretreated produced water stream;
a membrane separation unit downstream of the pretreatment system, the membrane separation unit configured to receive the pretreated produced water stream to produce a permeate stream and a retentate stream, wherein the KHI is concentrated in the retentate stream;
an analyzer configured to analyze the retentate stream to determine properties of the concentrated KHI; and
a regeneration process subsystem configured to recover the KHI from the retentate stream.
